(19) United States
(12) Patent Application Publication
(10) Pub. No.: US 2017/0222288 A1
(43) Pub. Date: Aug. 3, 2017

(54) Zinc-Air Prismatic Battery Configuration

(71) Applicants: Chris Ashfield, Seattle, WA (US); Donald Montgomery, Shoreline, WA (US); James O'Malley, Cheyenne, WY (US)

(72) Inventors: Chris Ashfield, Seattle, WA (US); Donald Montgomery, Shoreline, WA (US); James O'Malley, Cheyenne, WY (US)

(73) Assignee: Nanomaterials Discovery Corporation, Cheyenne, WY (US)

(21) Appl. No.: 15/011,554

(22) Filed: Jan. 30, 2016

(51) Int. Cl. H01M 12/06; H01M 2/16; H01M 4/66; H01M 2/12; H01M 4/86; H01M 6/50; H01M 2/20; H01M 4/06; H01M 4/90

(52) U.S. Cl. CPC H01M 12/065; H01M 4/06; H01M 2/1626; H01M 4/661; H01M 4/9016; H01M 4/8626; H01M 6/5083; H01M 2/204; H01M 2/12; H01M 2004/027

(57) ABSTRACT

There is disclosed a cartridge for a portable electronic device power system configured as a flat, prismatic, air-breathing zinc-air battery comprising (a) an anode assembly having a structural backbone, current collectors, and a gel solution comprising a mixture of amalgamated zinc powder, aqueous potassium hydroxide and a gelling agent, (b) a porous separator sheet, and (c) an air-breathing cathode having an electrode impregnated with reductive catalyst, and (d) a serialized electrical connectivity path having low ohmic resistance characteristics. More specifically, there is disclosed a prismatic format, flat rectangular disposable primary battery having two or more zinc-air batteries connected in series, wherein each zinc air battery comprises: (a) an anode assembly having a structural backbone, current collectors, and a gel solution comprising a mixture of amalgamated zinc powder, aqueous potassium hydroxide and a gelling agent, (b) a porous separator sheet, and (c) a catalytically active oxygen-reductive cathode.

### CROSS REFERENCE TO RELATED APPLICATION

This patent application claims priority to U.S. provisional patent application 62/110,279 filed 30 Jan. 2015.

### TECHNICAL FIELD

The present disclosure provides a cartridge for a portable electronic device power system configured as a flat, prismatic, air-breathing zinc-air battery comprising (a) an anode assembly having a structural backbone, current collectors, and a gel solution comprising a mixture of amalgamated zinc powder, aqueous potassium hydroxide and a gelling agent, (b) a thin porous separator sheet composed of non-woven cellulose, (c) a cathode having an electrode impregnated with catalyst for purposes of reducing molecular oxygen from ambient air, and (d) a serialized, parallel, or combination of series and parallel electrical connectivity path having low ohmic resistance characteristics. More specifically, the present disclosure provides a prismatic format, flat rectangular disposable primary battery having two or more zinc-air batteries connected in series, in parallel or in combination of parallel and series, wherein each zinc air battery comprises: (a) an anode assembly having a structural backbone, current collectors, and a gel solution comprising a mixture of amalgamated zinc powder, aqueous potassium hydroxide and a gelling agent, (b) a porous separator sheet, and (c) a catalytically active carbon-based cathode having the capability of reducing oxygen from ambient air, wherein the cathode electrode is impregnated with catalyst Manganese (III) oxide and Manganese (IV) oxide.

### BACKGROUND

Zinc-air batteries have been made in different form factors, but generally not in a rectangular prismatic configuration such as integrated into a mobile phone casing in order to provide power to run and recharge the mobile device for extended periods of time, such as 2-4 hours, or 24-48 hours. Moreover, such power sources have a single battery having single current collector electrodes, rather than a design with serial or parallel connections with two or more prismatic zinc-air cells.

Batteries sold in the marketplace generally consist of secondary batteries (rechargeable) and primary batteries (single use). Secondary batteries, such as lithium ion, are used as the power and energy source in large volumes for many applications including smart phones and other consumer electronic devices, back-up or reserve power units, and in all-electric automobiles, among other applications. Primary batteries include Alkaline Batteries (“AA”, “AAA”, “C”, “D” and 9-volt batteries, as examples), and lithium metal variants that are packaged in the same format as the alkaline chemistry variant in order to readily populate the same market. Lithium metal AA batteries last longer (more energy capacity), have higher current output capacity (high drain applications) and are lighter than an alkaline chemistry variant, however, they are four to five times more expensive than the alkaline variant.

Secondary batteries are generally used in smartphones, tablets, phablets, and laptops (collectively, “consumer electronic devices”), in medical industry specific devices, and in military industry specific devices. Often, these batteries are lithium-ion batteries (note that “lithium-ion” and “lithium” metal are different technologies, the former is a secondary battery and the latter is primary). The principal benefit of secondary batteries is their ability to be recharged many times, often greater than 500 cycles, without experiencing significant performance loss. Their drawbacks include cost and total capacity. Disposal issues related to both lithium metal and lithium-ion batteries are present due to toxicity concerns and cost.

A zinc-air battery is a type of metal-air battery. The technology differs from alkaline batteries, and from lithium and lithium-ion batteries, operationally due to use of an air-accessible cathode as a catalytic structure designed to facilitate reduction of oxygen. Metal-air batteries, such as zinc-air, have a number of benefits over one or more of the aforementioned battery technology type, including (1) low cost, (2) high specific energy density, (3) environmentally inert chemicals, and (4) superior performance in high current drain applications.

However, given the attractive performance and cost characteristics, the markets for metal-air cells are still rather limited and underdeveloped. Small, portable, canister-type zinc-air batteries manufactured and sold in commercial markets are mainly limited to hearing aid batteries that are, by design, limited to low power outputs, and are instead designed for longer lifetimes. Metal-air technologies including zinc-air batteries, may suffer from high volume manufacturing costs due to the difficulty in maintaining a robust seal to avoid leaking. In addition, a “button cell” zinc-air product remains the dominant commercial form factor. Additionally, zinc air batteries have not achieved rectangular form factors commercially due to a significant problem of uneven stresses on battery seals as the battery operates, and due to chemical incompatibility with the highly alkaline anode chemicals.

Lastly, there has been very little uptake of primary batteries of either the alkaline, or higher performing lithium metal, formats for use with consumer electronic devices. This is likely due to cost versus performance issues for either alkaline batteries (weight, performance) or lithium metal batteries (cost, disposal) and in the case of both alkaline and lithium metal embodiments, a consequence of the undesirable cylindrical form factor (“AA” batteries, as an example) for use as a back-up energy source for modern consumer electronic devices.

### SUMMARY

The present disclosure provides a cartridge for an electronic device power system configured as a flat, prismatic, air-breathing zinc-air battery comprising (a) an anode assembly having a structural backbone, current collectors, and a gel solution comprising a mixture of amalgamated zinc powder, aqueous potassium hydroxide and a gelling agent, (b) a thin porous separator sheet composed of non-woven cellulose, (c) a catalytically active oxygen-reduction cathode having an electrode impregnated with catalyst, and (d) an electrical connectivity path having low ohmic resistance characteristics. Preferably, the catalytically active oxygen-reduction cathode is made from nickel metal in the form of an expanded mesh or a metallic plate with holes or a woven mesh. Preferably, the anode current collectors are made with brass which also forms the anode backbone. Preferably, the multiple zinc-air cells are in serial electrical contact, or in parallel, or in a combination of electrical series and parallel contact. Preferably, the catalytically active oxygen reduction cathode catalyst is Manganese (III) oxide or Manganese (IV) oxide.

The present disclosure further provides a prismatic format, flat rectangular disposable primary battery having two or more zinc-air batteries, wherein each zinc air battery comprises: (a) an anode assembly having a structural backbone, current collectors, and a gel solution comprising a mixture of amalgamated zinc powder, aqueous potassium hydroxide and a gelling agent, (b) a separator sheet, and (c) a catalytically active oxygen-reduction cathode having an electrode impregnated with catalyst. Preferably, the two or more zinc-air batteries are connected in series, or in parallel, or in a combination of series and parallel, and wherein each of the cathodes are aligned in a single geometric plane or are aligned in a biplanar configuration, whereby biplanar means two substantially parallel, opposite facing planes. Preferably, the primary battery further comprises a circuit to control battery power output by controlling the current output as a function of the voltage, reading the voltage, and optionally raising or lowering the output voltage of the primary battery. More preferably, current output is controlled with a current ladder. Preferably, the catalytically active oxygen reduction cathode catalyst is Manganese (III) oxide or Manganese (IV) oxide. Preferably, the separator sheet is cellulosic and nonwoven.

Preferably, the primary battery further comprises a welded seal around each of the two or more zinc-air batters, whereby the welded seal contains any volume expansion of the zinc upon discharge (zinc oxidation) of the primary battery. Alternately, the seal may be formed by use of adhesives. More preferably, the primary battery further comprises a plurality of microspheres enclosing a vacuum, whereby expanding pressures will collapse the microspheres. More preferably, the primary battery further comprises a bellows-like structure that is compressible with a vent to provide for expelling a gas, e.g., air.

The present disclosure provides a flat, prismatic, multi-cell zinc-air battery (“Battery Cartridge”), and may optionally contain an electronic circuit specially designed to (1) provide for an electrical connection between the Battery Cartridge and a variety of consumer electronic devices, and (2) to maximize the performance of the Battery Cartridge with regard to the consumer electronic device being powered or recharged. Surprisingly, the disclosed prismatic multi-cell zinc-air battery achieved approximately two to three times the power density of a prior art Energizer zinc-air battery (see Tables 6 and 7 below). The Battery Cartridge is a disposable or returnable, primary (single use) device and the Specialty Circuit is reusable. In a preferred embodiment, the Specialty Circuit is contained within a housing unit for protection and for ease-of-use by end users. In another preferred embodiment the Specialty Circuit is housed within a smartphone protective case commonly utilized by smartphone end users to protect their device from physical damage (the “Protective Case”).

### DESCRIPTION OF DRAWINGS

FIG. 1 shows an embodiment of the present disclosure configured as a power unit for a mobile phone with a mobile phone case.

FIG. 2 shows a metallic Battery Cartridge embodiment of the present disclosure being inserted into a mobile phone case.

FIG. 3 shows a schematic of a four cell assembly.

FIG. 4 shows a breakout assembly of each component of an individual zinc-air cell

FIG. 5 shows a concept rendering of the complete prototype assembly for usual and customary integration with a consumer electronic device, and especially including all of the embodiments as described herein. An iPhone 5 rendering is used as the example consumer electronic device to be charged. In Frame (A), the smartphone Protective Case with the onboard integrated Specialty Circuit (Example 2) are shown. The Specialty Circuit is contained wholly with the Protective Case, which can be seen at the bottom of the image. Frame (B) depicts the iPhone 5 docking with the Case and interlocking to make electrical contact with the Specialty Circuit. Frame (C) depicts a ring-like fixture snapping over the Protective Case. The rendering of this particular Protective Case concept contains such a feature. Frame (D) depicts the backside of the Protective Case rendering. The indented area is the empty space reserved for the Battery Cartridge, which is currently not engaged. Frame (E) depicts a Battery Cartridge ready for insertion. Frame (F) depicts the completed system. The Battery Cartridge is now servicing the power and energy needs of the iPhone 5.

FIG. 6 shows a sequence rendering of the disclosed Zn air battery. In Frame (A), the smart phone Protective Case with the onboard integrated Specialty Circuit (Example 2) are shown. The backside of Protective case seen here, the Specialty Circuit is contained within protective housing at the bottom of the case. In Frame (B) a Battery Cartridge (Example 2) is introduced. Frame (C) depicts the complete product concept.

FIG. 7 shows a Battery Cartridge with protective air impermeable sheath that is substantially similar in size to a “credit card”. End users of the Product Concept Battery Cartridge would benefit from the portable nature of the product and ease-of-use.

FIG. 8 shows a circuit and data in the LT1512 datasheet (available from Linear Technology Corp).

FIG. 9A shows a circuit added to interface the 1512 with the on-board microcontroller.

FIG. 9B shows an LTC4411 that allows full control over which power source is used, and for which current losses are minimal.

FIG. 10 shows a Specialty Circuit, LED circuit, button and ribbon cable as reduced to practice is depicted below (left). On the right, a concept of a Protective Case is depicted with the location of where all the components are placed.

FIG. 11 shows a rendering of the Components of the Protective Case. More specifically, FIG. 11 depicts a rendering of the example Protective unit designed to accept the invented Battery Cartridge (A) and containing the following components: (B) hinge rod, (C) silicone part, (D) spring plunger (ct. 2), (E) switch, (F) case top part, (G) screw, 1.5 mm (ct. 2), (H) case lower part, (I) soft touch insert, (J) Specialty Circuit holder, (K) speaker grill, (L) iPhone 5 (example consumer electronic device to be used by the Protective Case).

FIG. 12 shows an example of the just the Protective Case reduced to practice (left), and the Protective Case combined with an iPhone 5 and prototype Battery Cartridge (right; note the rubber band is not necessary).

FIG. 13 shows a voltage (V) response versus time (hours) for Prototype 1 with the discharge conditions described in Example 4.

FIG. 14 shows a current (A) response versus time (hours), and total energy (Wh) with the discharge conditions in Example 4.

FIG. 15 depicts the voltage response versus time for prototype 2. The measurement represented the electrochemical potential (voltage) of the prototype cartridge device which contained three individual zinc-air cells interconnected in electrical series by soldered nickel mesh tabs between the cells, and copper-foil tabs conjoining the protruding electrodes for connection to the programmable load.

FIG. 16 shows current (A) response versus time (hours), and total energy (Wh) for Prototype 2.

FIG. 17 shows Prototype 3 with a Special Circuit input and output voltage.

FIG. 18 shows Prototype 3 with a Special Circuit input and output current.

FIG. 19 shows Prototype 3 with a Special Circuit input and output power.

FIG. 20 shows Prototype 3 with a Special Circuit input and output energy.

FIG. 21 shows the charge indication of an iPhone 5c

FIG. 22 shows Prototype 3 with a Special Circuit estimated total charging circuit efficiency.

FIG. 23 shows voltage response versus time. The voltage (V) response versus time (hours) as described by the aforementioned discharge conditions, is depicted below. The measurement represented the electrochemical potential (voltage) of the prototype cartridge device which contained three individual zinc-air cells interconnected in electrical series by soldered nickel tabs between the cells, and copper-foil tabs conjoining the protruding electrodes for connection to the programmable load.

FIG. 24 shows electrochemical potential (voltage) of the Prototype 4 cartridge device which contained three individual zinc-air cells interconnected in electrical series by soldered nickel tabs between the cells, and copper-foil tabs conjoining the protruding electrodes for connection to the programmable load. The current (A) response versus time (hours), and total energy (Wh).

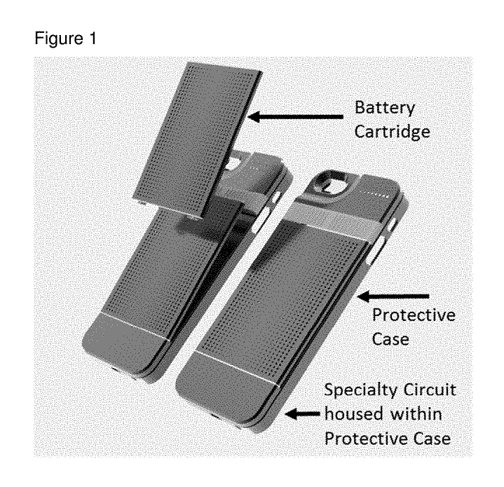

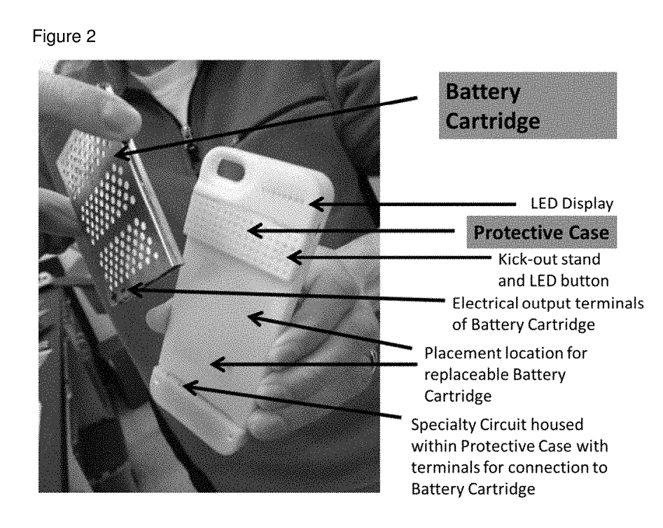

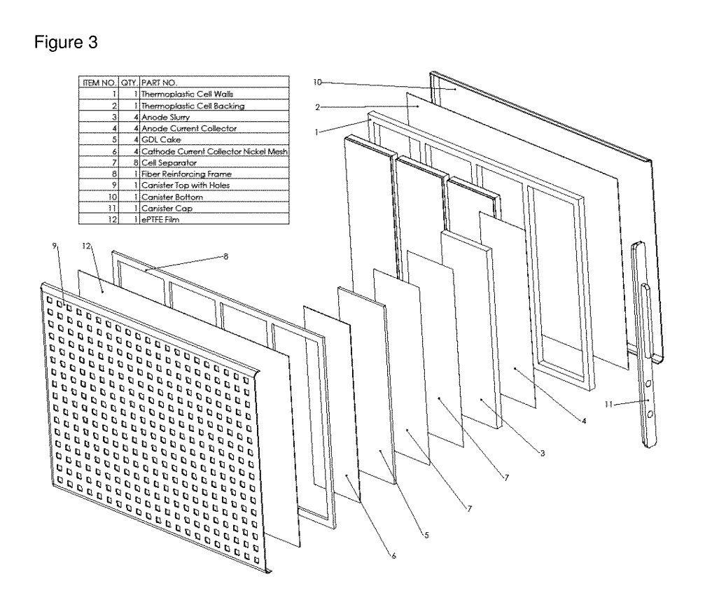

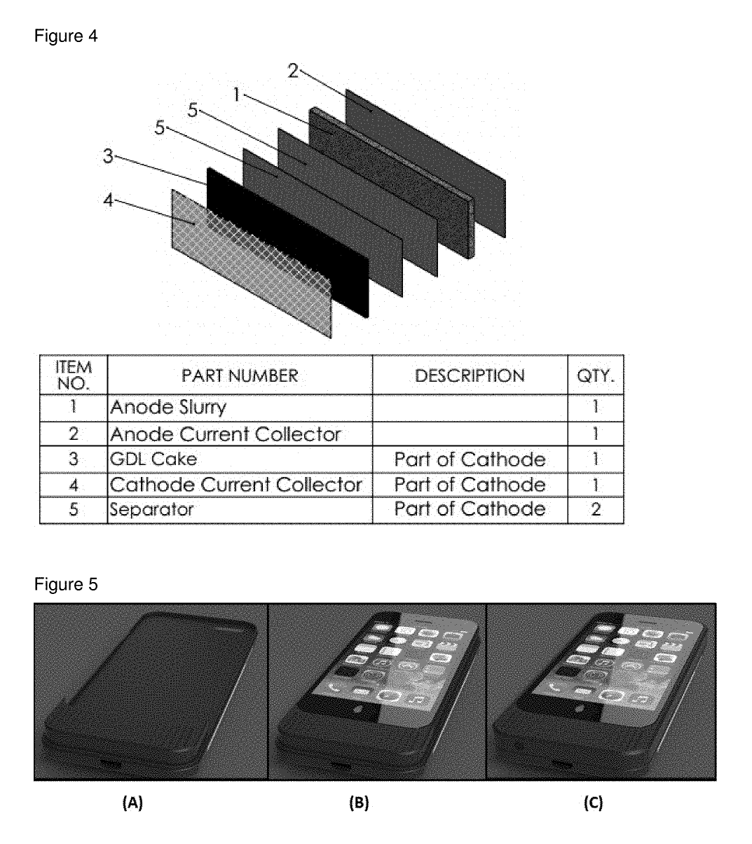

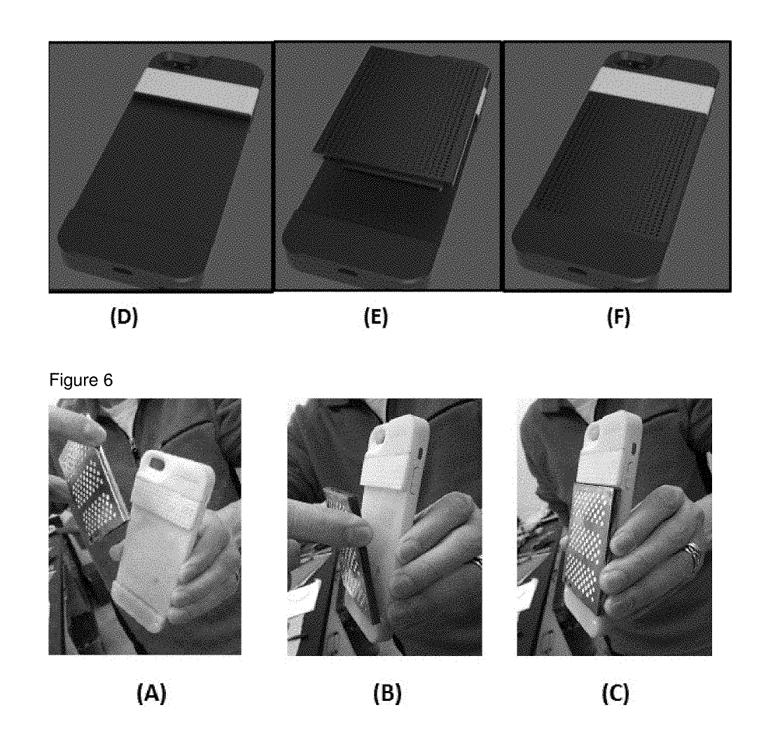

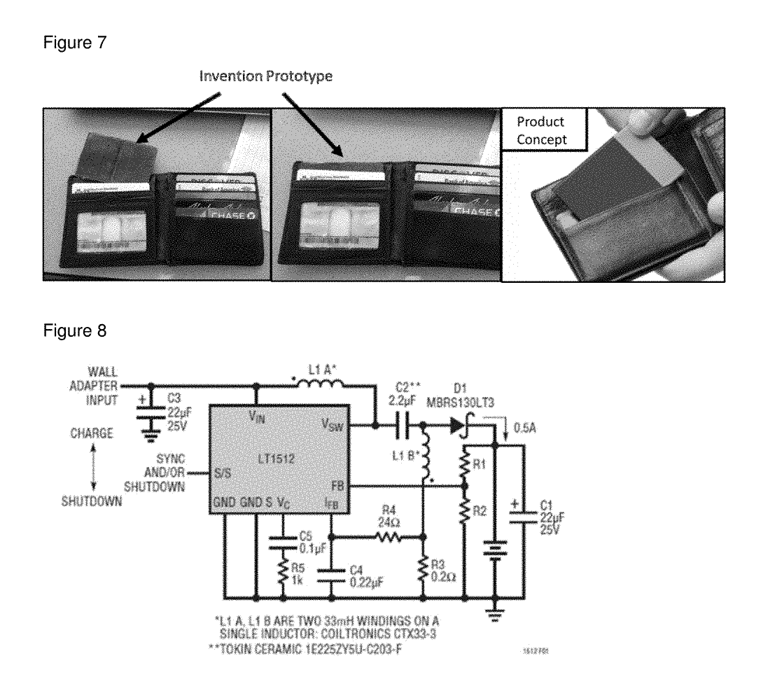

### DETAILED DESCRIPTION

There is a need for a primary battery designed specifically for the operational purpose of recharging consumer electronic devices that meets or exceeds all of the aforementioned shortcomings of the current products based on incumbent technologies. In particular, the disclosed zinc-air battery: (1) is inexpensive, (2) has a high energy storage capacity, (3) is environmentally friendly, (4) performs well in high current drain applications, and (5) possesses a haptic form factor conducive for use with, and connectivity to, modern consumer electronic devices.

Metal-air cells typically include a metal anode, an air cathode, and a separator all disposed and supported in some sort of container. The metal anode usually comprises a fine-grained metal powder, such as zinc, aluminum, or magnesium, which is blended together with an aqueous electrolyte, such as potassium hydroxide, and a gelling agent into a paste. The separator is a porous material that allows the passage of electrolyte between the cathode and anode, but prevents direct electrical contact and short circuiting of the cell. In a preferred embodiment, the Battery Cartridge comprises three separate zinc-air cells connected in electrical series. In another preferred embodiment, the Battery Cartridge contains four separate zinc-air cells connected in electrical series.

The present disclosure provides a primary battery format that is rectangular, or prismatic, and roughly the size of a credit card. The disclosed battery comprises one or a plurality of individual zinc air batteries connected in series or parallel. The disclosed prismatic batteries are able to achieve rapid power outputs by having a porous separator composed of cellulosic non-woven material, such as a tissue wipe.

Air may access the zinc-air battery from one or both sides of the prismatic battery format by passive diffusion or by active convection using an internal or external fan. The format in which cavities are formed to hold the zinc and electrolyte formulations. These cavities are formed in a monolithic component or as composite components in the format. An electrical means to contact these cavities is integrated into the format and may comprise at least one of the walls of the one or more cavities. The monolithic or composite construction of the format may be formed from any number of materials such as plastics, waxes, composites and the like. The format may be produced from these materials by manufacturing methods such as subtractive or additive machining, injection molding, transfer molding and the like. The format has one or a plurality of cathodes proximate to the surface such that the cathode may have access to external air on one or both sides. A venting means is placed between the cathode and the external air that serves as a mechanical barrier to prevent damage to the cathode and as a way to control the amount of air that can contact the cathode, thereby limiting the amount of current that the cathode can support.

The cathode is sealed into the cavities in the format. Sealing means include the use of a separate sealing gland, such as an o-ring, that is compressed between an edge of the cathode and an edge of the cavity. Alternatively, the edge of the cathode may be sealed to the edge of the cavity by welding using insulating material such as plastic that is caused to make the seal by thermal, ultrasonic, pressure, electrical and/or other means that are known in the art. Alternatively the edge of the cathode may be sealed to the edge of the cavity by use of an adhesive.

Preferably, electrical circuitry may be integrated into the format to form connections between battery cells. More preferably, such electrical circuitry provides for sensors that monitor the health of the system, for example state-of-charge, temperature, resistance, voltage and the like, and to condition the electrical power signal provided to an external load.

The prismatic battery further comprises an electrical connector means to contact an external load. The disclosed prismatic battery further is packaged in a sealed container that prevents oxygen from contacting the cathode. This may comprise one or more peel away stickers that cover the surface of the one or more cathodes, or an oxygen impermeable bag, such as an aluminized Mylar bag, in which the format is placed.

The present disclosure further provides an ability to recycle the prismatic battery to reclaim or process materials and components and to regenerate the zinc metal for reuse.

Another advantage of the disclosed flat prismatic zinc-air battery configuration is a cathode structure with an edge feature that allows sealing around a cavity in the format using a welding or adhesion method. This cathode structure prevents leakage of electrolyte from a sealed zinc-air battery cell. Therefore, this forms a cathode comprised from a catalyst that is robust to electrolyte flooding and that can provide and sustain a rate of power production in terms of watts/cm² that is sufficient to meet the performance metrics of the disclosed prismatic battery.

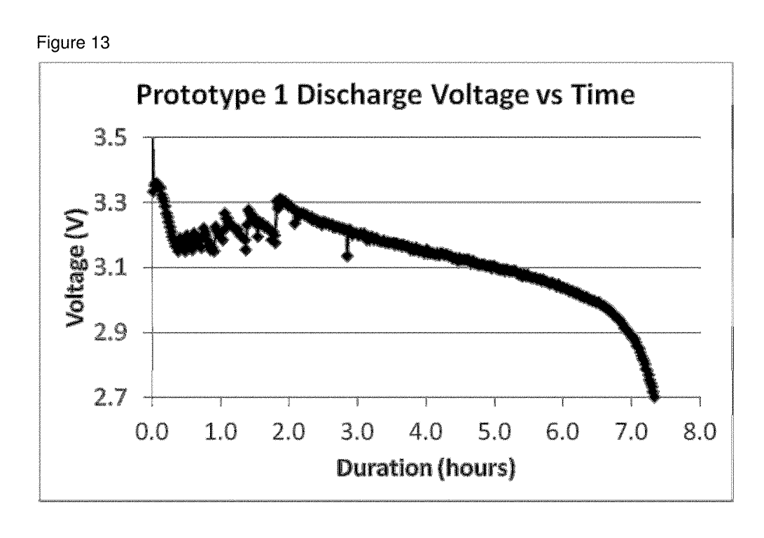

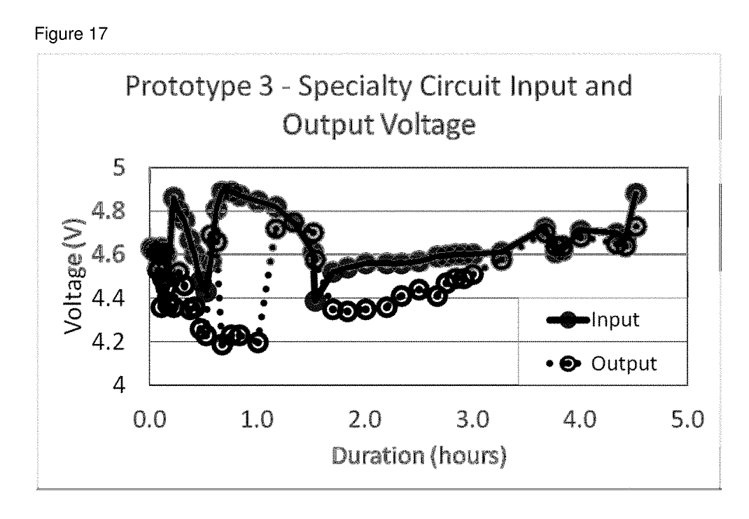

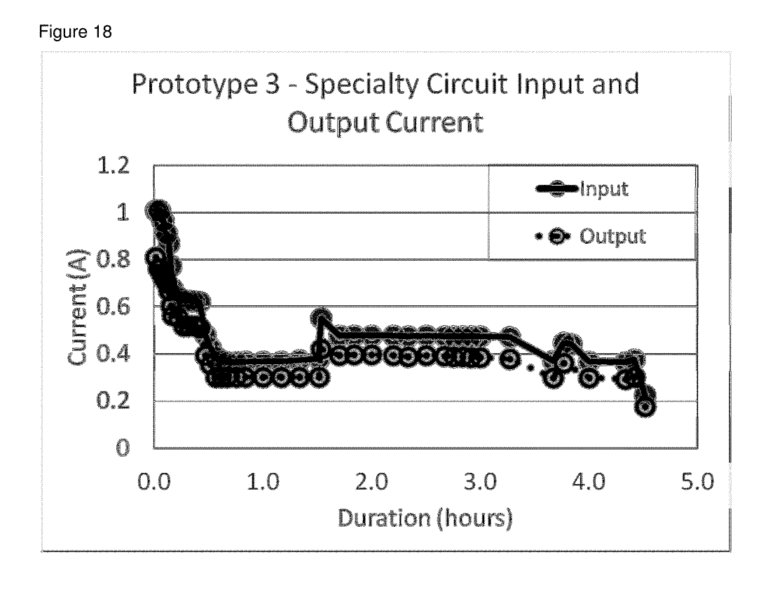

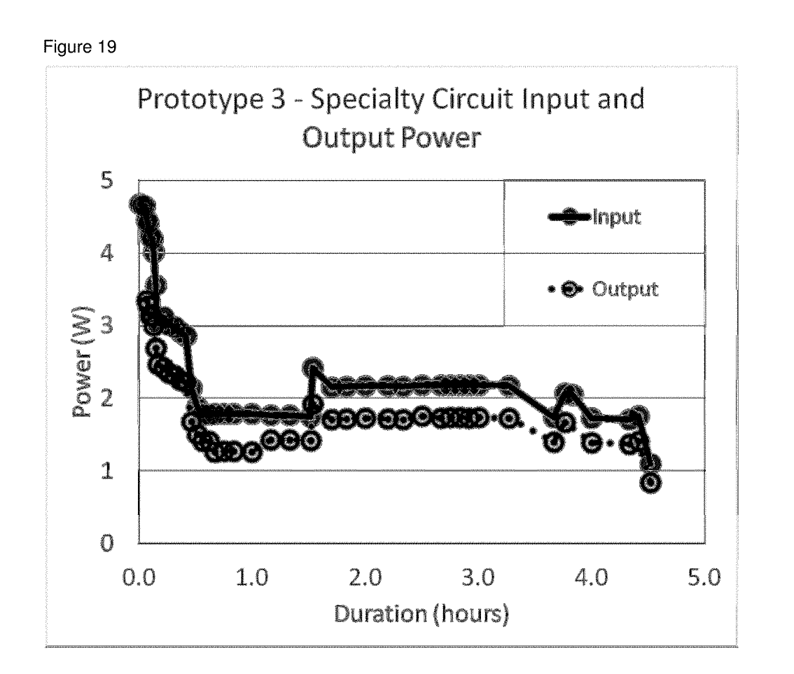

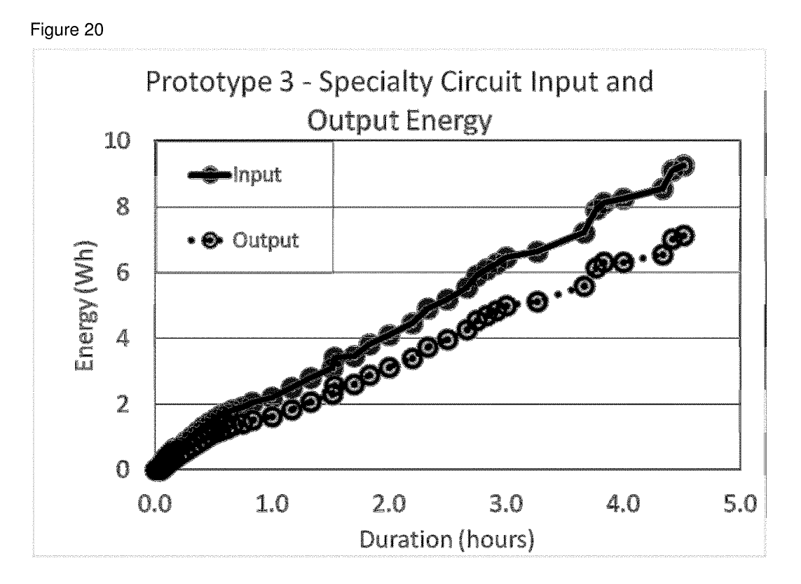

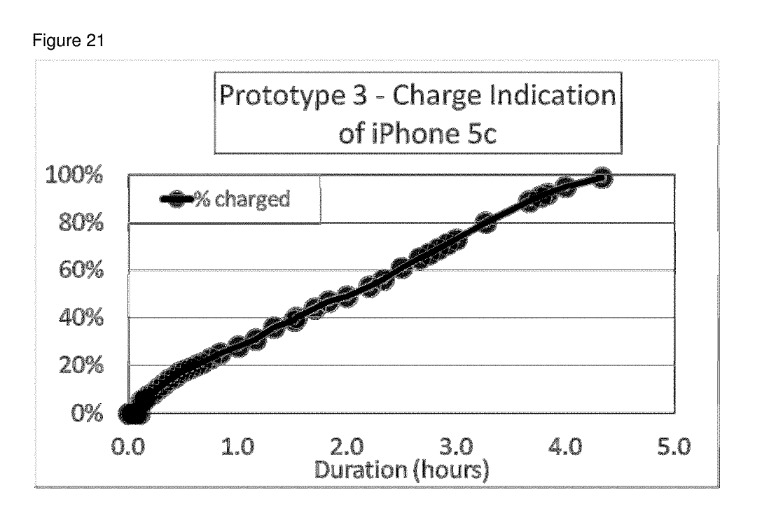

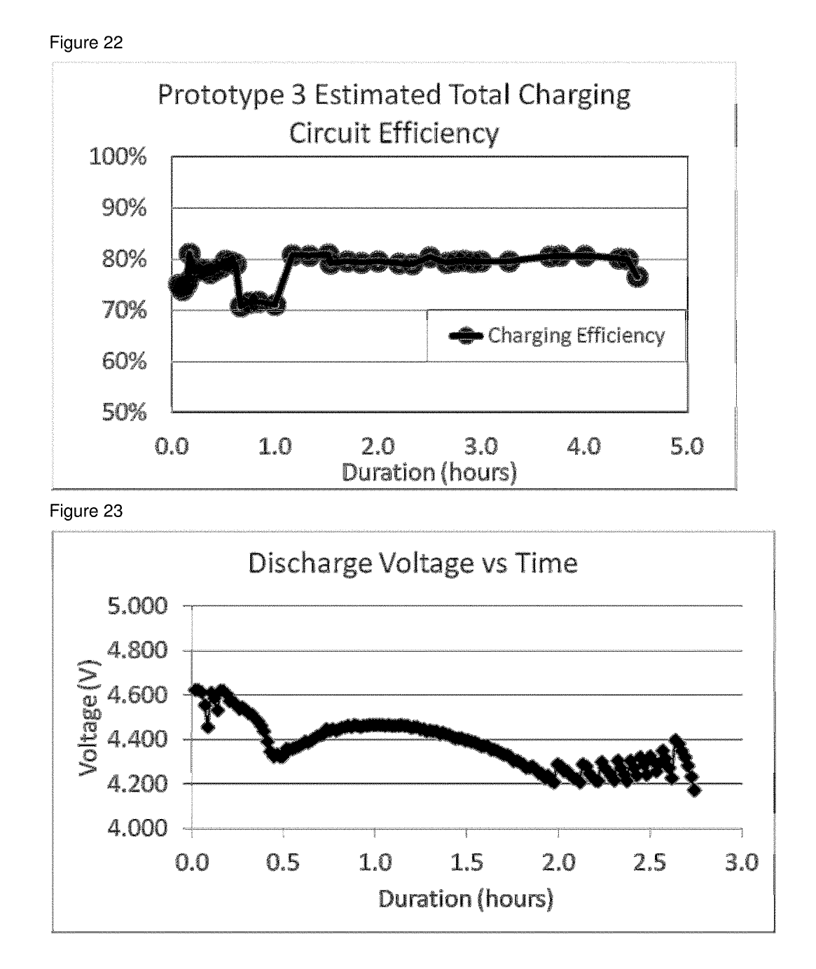

The disclosed zinc-air battery anode formulations provide the rapid performance metrics as indicated by the Data shown in FIGS. 13-24. A mixture of zinc in a basic electrolyte provides for the performance metrics. Zinc is preferably alloyed with a co-agent that minimizes the formation of hydrogen. Zinc particles are of a size and a size distribution that allow the performance metrics. The electrolyte is preferably potassium hydroxide (KOH) that is gelled using an additive. Preferably, there is also a void volume to allow for expansion of the electrolyte during use due to formation of solid zinc oxide.

### Commercial Advantages

In a preferred embodiment, the Battery Cartridge contains three separate zinc-air cells connected in electrical series. In another preferred embodiment, the Battery Cartridge contains four separate zinc-air cells connected in electrical series. The Battery Cartridge is designed for maximum power output relative to its size, which equates to faster charge times for modern, power-intensive consumer electronic devices. The anode integrates an anode formulation (amalgamated zinc, electrolyte, gelling agent formulation), hydrogen generation suppression, separator development and testing, and cathode integration and current collection elements that are custom in nature (detailed in Example 1).

The Battery Cartridge provides for a method for increasing the usable airflow and access through the use of a custom cathode and separator assembly. This allows for the ability to charge a contemporary smart phone or consumer electronic device completely in 1 to 7 hours with a “credit card” sized Battery Cartridge. The Battery Cartridge utilizes multiple cells in a side-by-side, and/or top and bottom configuration to minimize space, and maximize airflow allowing for high current drain applications. A preferred embodiment is a flat, prismatic zinc-air battery with a surface area size about that of a “credit card,” and a thickness of 6 mm or less, that can recharge a battery onboard a smart phone (for example “iPhone 5”) completely (0 to 100% charge) in 4 hours or less.

In addition, a custom electronic circuit and firmware protocol is described (together, the “Specialty Circuit”, see Example 2) that serves to (1) interface the Battery Cartridge seamlessly and safely with the consumer electronic device, (2) maximize the total energy output of the Battery Cartridge, (3) maintain the highest output current of the Battery Cartridge, and (4) cut the Battery Cartridge power once the absolute voltage reaches the range where undesirable deep-discharge would normally occur. The specialty circuit was designed, fabricated and tested with the Battery Cartridge. The invention consists of a Battery Cartridge as previously described coupled with the Specialty Circuit.

### Anode Element

The anode provides for the “gel” that is prepared with a solution of 11 M KOH and 1.6% weight CMC (carboxymethylcellulose). Separately, a slurry is prepared by mixing 0.6903 grams powdered zinc (Zn) with 0.3097 grams of the gel solution. For a 4-cell configuration, the amount of Zn and CMC/KOH solution per cell would be 3.689 g and 1.655 g, each, respectively (note this is 14.757 g Zn and 6.619 g CMC/KOH solution total for device and is divided equally among all the cells). A preferred ratio is 2.23 parts zinc metal per one (1) part “gel solution.” In one example, there is a total of 21.376 g of anode chemistry in the entire device. The only specification is that the total anode chemistry is partitioned equally into each cell, by weight.

TABLE 1
Cost and Performance Comparisons of a Mobile
Phone Embodiment with Incumbent Technologies:

| | | | | | Specific | | |
|---|---|---|---|---|---|---|---|
| | Retail Cost | | Energy | Weight | Energy | Cost per Wh | |
| Battery Type | Low | High | (Wh) | (g) | Wh/kg | Low | High |
| AA Alkaline | $0.33 | $0.75 | 2.1 | 23 | 91 | $0.16 | $0.36 |
| Battery | | | | | | | |
| AA Lithium | $1.50 | $4.00 | 3.7 | 15 | 247 | $0.41 | $1.08 |
| Battery | | | | | | | |
| Invention | $1.49 | $2.49 | 14.0 | 46 | 304 | $0.11 | $0.18 |

The Battery Cartridge utilizes materials and processes capable of producing units at significantly reduced cost versus incumbent primary battery products. A preferred embodiment uses relatively inert and environmentally harmless materials that are readily available. In a preferred embodiment, a Battery Cartridge can be manufactured for less than $1.00 in materials, preferably about $0.55 in materials, or about $0.35 in materials, or even about $0.27 in materials.

TABLE 2
Comparison of Two Common Commercial Batteries
with the Preferred Embodiment.

| Battery Type | Low Cost | High Capacity | High Drain | Environment |
|---|---|---|---|---|
| AA Alkaline | Yes | No | No | Good |
| Battery | | | | |
| AA Lithium | No | Yes | Yes | Fair/Poor |
| Battery | | | | |
| Disclosed | Yes | Yes | Yes | Good |
| Invention | | | | |

This cost and performance of the disclosed Battery Cartridge allows for the use of a zinc-air battery as a primary (throw-away/recycle/return) battery, with, for example, high-duty cycle, smartphones, tablets, laptops and consumer electronic devices.

### Cathode Element

An air cathode is a planar structure designed to facilitate the reduction of oxygen by use of a specialized catalyst. Preferably, the specialized catalyst is Manganese (III) oxide or Manganese (IV) oxide. Typically, it is composed of active carbon, a binder, and a catalyst which, together with a metal current collector, are formed into a thin sheet. An air cathode also commonly incorporates a hydrophobic polymer, such as polytetrafluoroethylene or polystyrene, directly into the cathode sheet and sometimes also as a coextensive film. The hydrophobic polymer prevents electrolyte from flooding the cathode or passing through it and leaking from the cell. A cathode container includes oxygen access openings, diffusion chambers which are designed to allow sufficient oxygen to reach all parts of the air cathode.

The cathode contains a Gas Diffusion Layer (GDL) that allows oxygen permeation into the Battery Cartridge and inhibits fluid from leaking or transferring out of the Battery Cartridge, and that allows for electrical current with low-ohmic related losses. In a preferred embodiment, the GDL comprises a fine carbon powder and (poly)tetrafluoroethylene (PTFE) binder.

In a preferred embodiment the cathode contains the following components and simultaneously performs the following functions enumerated below in a passive environment:

(1) The cathode contains the aforementioned GDL compressed and flattened onto a nickel-mesh or expanded nickel backbone that serves as to collect the electrical current and transmit out of the cathode. In a preferred embodiment, the electrical current supported by the GDL and nickel current collection backbone is at least 30 milliamps per square cm (mA/cm²), as operated under the conditions of the Battery Cartridge testing disclosed herein. In another preferred embodiment, the electrical current supported by the GDL and nickel current collection backbone is at least 46 mA/cm². In yet another preferred embodiment, the electrical current supported by the GDL and nickel current collection backbone is at least 64 mA/cm². In yet another preferred embodiment, the electrical current supported by the GDL and nickel current collection backbone is at least 100 mA/cm². The GDL may or may not contain oxygen reductive catalyst.
(2) Have one major surface that allows access to ambient air through the Gas Diffusion Layer (GDL).
(3) Have a second major surface contained wholly within the Battery Cartridge that has intimate contact with the electrolyte solution via a wetted separator that prevents electrical contact between the Anode Element and the Cathode Element, but is permeable to electrolyte.
(4) The primary function of the second major surface is for the purpose of reducing oxygen from ambient air to aqueous dissolved hydroxide ion.
(5) Contain an active catalyst at the aforementioned second major surface for purposes of effectuating the oxygen reduction reaction.

A preferred Battery Cartridge is a zinc air battery having three or four contiguous yet independent cells. In one preferred embodiment, a function specification of the Battery cartridge is listed in Table 3:

TABLE 3
One preferred Embodiment of the Battery Cartridge Specification

| Parameter | Requirement | |
|---|---|---|
| Battery Type | Zinc/Air | |
| Primary/Secondary | Primary | |
| Number of Cells | 2 or more | |
| Open Circuit Voltage (OCV) | 5.60-5.95 V (4-cell example) | |
| Operating Voltage | 4.20 - OCV; 4.20-4.40 | |
| | (typical, 4 cell example) | |
| Operating Current | 1.3 A-0.3 A | |
| Capacity | 3,500 | mAh |
| Average Power | >1.5 | W |
| iPhone 5s charge time (0-100%) | <4 | hours |
| Preferred maximum sustained current | 1.3 | A |
| Minimum time at Maximum current | 20 | minutes |

| | |
|---|---|
| Initial State of Charge | 100% |
| Depth of Discharge (spent) | >90% |
| Shelf Life (no air exposure) | >12 months with <25% |
| | Capacity Loss |
| Lifetime once package | >24 hours with <25% |
| is opened (air exposure) | Capacity Loss |

In another preferred embodiment, the Battery Cartridge conforms to the specifications listed in Table 4:

TABLE 4
One preferred Embodiment of the Battery Cartridge Specification

| Parameter | Specification | | Variable Parameters |
|---|---|---|---|
| Surface Area (cm²) | >9.18 | cm² | Length and Width |
| | | | of design |
| Volume Anode Slurry | 1.836 | mL | |
| Anode wall height | 2.0 mm or less | | |
| | (current example) | | |
| Mass Anode Slurry | 5.344 | g | Adjustable based on |
| | | | desired energy output |
| Thickness (Top of cathode | <3.0 | mm | |
| to bottom of Anode current | | | |
| collector) | | | |
| Individual zinc-air cell | 17 | mm | Adjustable based on |
| length | | | desired power output |
| Individual zinc-air cell | 54 | mm | Adjustable based on |
| length | | | desired power output |

| | |
|---|---|
| Separator Wetting | 10 uL/cm2, 13M |
| | KOH solution |

In a preferred embodiment, the Battery Cartridge and Specialty Circuit provide an interface with a consumer electronic device through a specially designed electronic circuit (the “Specialty Circuit”, see Example 2). In a preferred embodiment, the Battery Cartridge has the following components:

Two (2) or more individual cells contained and sealed in a housing structure

Two (2) or more individual cells contained and sealed in a substantially inflexible housing that must be able to withstand high alkalinity, liquid conditions.

A sealed plastic external canister/cartridge/skeleton with electrical terminal access, and perforations on one major face (the cathode side, air-breathing face or faces)

A removable, low-oxygen permeability barrier film to protect the cell during shelf life.

The following is a list of acceptable materials that can be used and are known to be inert with the battery's internal chemical components.

Hot-melt adhesive: Hot-melt adhesive (described in Example 1).

PE: polyethylene

PP: polypropylene

PTFE: polytetrafluoroethylene

PMMA: poly(methyl methacrylate)

### Cell Encapsulation/Sealing

To significantly lengthen shelf life, the Battery Cartridge is sealed in air-tight container, which serves to greatly increase shelf-life of the battery.

### EXAMPLE 1

This example illustrates Battery Cartridge fabrication. The Battery Cartridge device was a flat, prismatic, air-breathing zinc-air battery designed to integrate with an external electronic circuit and various housing apparatus embodiments, and then further integrated with a consumer electronic device for purposes of powering the consumer electronic device and/or recharging the secondary battery concomitant with the consumer electronic device. The device comprises of the following characteristics:

An integrated three (3) cell configuration which contains:

An anode assembly (the “Anode Assembly”), having a major backing surface (the “Backbone”) containing, in one example, a hot-melt adhesive and polyaramid (“Kevlar”) composite polymer to which three polished brass current collectors are affixed and exist in electrical isolation, and to which hot-melt adhesive walls were affixed, thereby forming an integrated assembly with a discreet anode compartment for each of individual cells.

A mixture of a amalgamated zinc powder of a controlled particle size (“Zinc”), potassium hydroxide (“KOH”), R.O. deionized water (“DI Water”), and a proprietary gelling agent mixture (the “Gelling Agent”, collectively, the “Chemistry”). The Chemistry provides higher electrical current drain than commercially available zinc-air battery products currently available, the latter of which usually provide for low-current drain and longer-lifetime applications (such as hearing aid batteries).

A specialized, catalytically active oxygen-reduction cathode (the “Cathode”), that is also optimized for high current drain applications and increased leaking potential. The Cathode further includes tensile-reinforced borders and a chemical separator (the “Separator”, collectively, the “Cathode Assembly”).

A serialized electrical connectivity path offering low ohmic resistance characteristics.

A seal between the Anode Assembly and the Cathode Assembly.

A thin, air-permeable, liquid repellent technical fabric sheet (the “Teflon Film”) overlaid above the three cell configuration to prevent further exposure should any individual cell leaking occur.

A 5-sided stainless steel metal frame with 2 major faces and 3 minor faces, wherein through-holes exist on one major face, and one additional minor face (the 6^{th} face) is reserved and open for purposes of inserting the above 3-cell assembly (the “Canister”).

A glass reinforced-Delrin end-cap (the “Endcap”) was affixed to the remaining 6^{th} face of the Canister that provided a final sealing interface for the cartridge and allowed for terminal electrical connectivity to a Specialty Circuit contained inside a Protective Case.

The Anode Assembly: The anode assembly has a layer of hot-melt adhesive/Kevlar backing material, three electrically isolated current collectors, and hot-melt adhesive walls. Briefly, the assembly is formed by injection molding the hot glue walls, then affixing the brass current collectors and Hot-melt adhesive/Kevlar composite in a separate welding process.

### Preparation of Anode Current Collectors

Each Anode Assembly required three polished brass current collectors, 0.127 mm thick with a soldered expanded nickel as current collector tabs. Expanded Nickel allows a liquid-tight seal while maintaining low resistance electrical contact.

Brass 260, ½ hard temper (McMaster Carr) was purchased as a 15.24 cm roll of 0.127 mm thickness is secured.

The brass was polished on a bench grinder equipped with a sewn cotton buffing wheel with a soft metal polishing component until a mirror-like finish was attained.

Brass was cut to approximate size of 15.24×15.00 cm.

Masking tape is used to secure the brass to an 18 cm×18 cm×0.5 cm steel plate.

A small amount of soft metal polishing component (Ryobi Soft Metal Cleaning Compound, “The White Stick”) is added to a 6″ sewn cotton buffing wheel.

Starting in one corner of the brass, successive passes were made on the buffing wheel working the way across until the whole piece of brass had a minor finish.

Brass was the cut with a shear to a size of 51.43×21.76 mm; each Anode Assembly requires 3 pieces.

Expanded nickel (Dexmet Corporation, Product 7Ni7-0.077-F-SR) was bought on a 30.5 cm roll. Tabs were soldered onto the unpolished face of each brass part such that they protruded 7.178 mm from the short dimension.

The brass was wiped clean with a Kimwipe and 70% isopropyl alcohol to remove residues remnant from polishing and soldering. The molded walls (the “Walls”) formed a sized, rectangular, prismatic anode cavity for each cell.

A mold is made from aluminum 6061.

The mold is sprayed with a silicone mold release (Mann Ease Release 200) from about 20 cm away for about 2-5 seconds. Each face of each mold half was sprayed.

The mold was then bolted closed with four M6×20 mm socket head cap screws, hand-tight.

A digital hot plate (Thermo Scientific) was set to 225° C. The closed mold was placed on the hot plate and heated until the upper plate was 160-180° C. A thermocouple was placed into a 1.5875 mm blind hole located in the upper plate for temperature sensing (not shown).

Once heated, the mold was removed from the hot plate and held in hand, protected by a thermally-insulating woven fiberglass mitten.

The hot-melt adhesive (Westward, Product Number 4YR50), was pumped into the mold cavity using a high-temperature glue gun (Surebonder Pro2-80) through the bottom-most of four injection/vent holes while the thermally insulated hand holds the mold vertically to assist the purging of gas bubbles from the casting. Hot-melt adhesive is pumped until no more bubbles were emerging from the other holes.

The mold and the glue gun were then partially submerged in a room temperature cooling water bath. Pressure was applied with the glue gun while the mold cools to prevent sinks and air bubbles in the casting.

When cool, the mold was removed from the cooling bath and the excess glue was removed by twisting the nubbins until they sever at the injection/vent holes' gates.

The mold was then opened and the casting is inspected for quality. Any castings with large bubbles or discontinuities were rejected. The casting was left in the mold for subsequent bonding.

### Preparation of Hot-Melt Adhesive Sheets and Hot-Melt Adhesive/Kevlar Sheets.

Sheets of hot-melt adhesive and Kevlar woven fiber-reinforced sheets (Hot-melt adhesive/Kevlar) formed The Backbone for the Anode Assembly. These materials were formed by sandwiching the hot-melt adhesive between two sheets of a release film (PTFE-coated fiberglass fabric (McMaster-Carr)), melting and pressing lightly and flat with a heated hydraulic 4-column press (the “Hot Press”), and then followed by subsequent cooling step. Sheets were initially pressed thicker than desired, and final thickness was set with a rolling mill prior to cooling. Each Anode Assembly required one Hot-melt adhesive sheet and one Hot-melt adhesive/Kevlar Sheet.

The Hot Press (Carver, USA) plates were preheated to 93.33° C.

A puddle of hot glue was dispensed with the glue gun onto a sheet of PTFE-coated fiberglass fabric. Another layer of PTFE-coated fiberglass fabric was placed on top.

The sandwich was inserted into the hot press and squeezed with gentle pressure (<1 metric ton) to form the glue sheet. Rough thickness was set to 1.0 mm with shim stock inserted during pressing.

While still heated, the sandwich was quickly, and while the glue remained a liquid, sent through a rolling mill for final sizing for a target thickness of 0.5 mm.

The sandwich was cooled on a flat concrete similar surface with a flat aluminum plate placed on top to assist in reducing cooling time.

The sheet was removed from the PTFE-coated fiberglass fabric by peeling the fabric from the glue sheet.

For hot-melt adhesive/Kevlar sheets: a double layer of woven Kevlar was inserted prior to dispensing the glue puddle, with the weaves of the two layers rotated relative to each other by 45 degrees, for a more isotropic rigidity. Target thickness size was 0.5 mm.

The finished sheets were cleaned with ethanol or isopropyl alcohol and cut to size (78.0×57.8 mm) using a steel rule die.

### Bonding the Anode Assembly

The Walls of the Anode Assembly were bonded to The Backbone with a liquid-tight seal which encapsulated the conductive expanded nickel tabs. This was accomplished in a single welding step using an Aluminum flat iron, and sized by shims (washers).

The upper half of the Hot-melt adhesive walls mold still had a casting inside it. The exposed face of the Hot-melt adhesive walls (the face to be bonded) was cleaned with ethanol or isopropyl alcohol of all mold release residues.

The brass current collectors were placed onto their respective places on the mold, such that the polished side was face down, pointed toward the internal cell cavities (soldered connections should be face up).

Brass was tacked into place by adding a drop of hot glue over the mesh tab, and gently and locally bonding it to the walls.

The hot glue sheet 0.5 mm was placed onto the mold on top of the brass current collectors. The Hot-melt adhesive/Kevlar sheet, 0.5 mm, was placed directly on top, followed by a sheet of parchment paper (release film).

4 stainless steel washers were used as shims, 0.70 mm thick, and were placed on the mold to assure a precise thickness of the finished, bonded Backbone.

The hot plate was set to 350° C., and an aluminum 6061 plate, about the same size as the mold (the “Flat Iron”), is placed on top and heated until it is 250° C., as sensed by a thermocouple placed in a 1.5875 mm hole in the size of the Flat Iron.

The Flat Iron was then placed on top of the parchment paper in order to melt the hot glue and bond The Backbone to The Walls. Pressure was applied to the handle of the flat iron, perpendicular to the mold, until the melted Backbone had reached the same thickness as the washer shims.

The Flat Iron was removed and the mold, containing the Anode Assembly, was cooled while sandwiched between large, thick, flat aluminum plates until room temperature.

After cooling, any nubbins which may have emerged from the injection/vent holes of the mold are then twisted out. The parchment paper was peeled away to reveal the formed Anode Assembly, which was then peeled out of the mold.

The Backbone-Walls interface was visually inspected for quality. Any assemblies with bubbles in the interface, or non-bonded interface were rejected.

### Chemically Active Battery Solution:

The chemically active battery solution (“anode slurry”) was blend of amalgamated zinc grains and a potassium hydroxide electrolyte gel. Electrolyte gel was prepared as follows:

18 M-Ohm Deionized Water;

Zinc doped with Indium and Bismuth (Grillo Werk Aktiengesellschaft, #000010-600376);

Carboxymethylcellulose, Sodium Salt, (High Viscosity, Sigma CAS # 9004-32-4); and

Potassium Hydroxide 90% (common chemical).

### Solution Prep:

Prepared a solution of 11 M KOH and 1.6% wt CMC (to be used in the anode).

Prepare a solution of 13 M KOH, only (to be used for non woven cellulose porous separator wetting).

Prepare the slurry by mixing 0.690335 parts powdered Zinc with 0.309665 parts CMC/KOH gel solution (% weight of each). Chemistry preparation was done in situ relative to the individual anode compartments following the synthesis of the entire 3-cell anode frame. For a 4-cell configuration, the amount of Zn and CMC/KOH solution per cell would be 3.689 g and 1.655 g, each, respectively (note this is 14.757 g Zn and 6.619 g CMC/KOH solution total for the device and is divided equally among all the cells). There was a total of 21.376 g of anode chemistry in such a device. Each cell was loaded with a blend of Zinc, KOH, and the Gelling Agent.

5.114 g of Zinc (Grillo Werks) were added to each cell as a dry powder.

3.80 g of Gelling Agent/KOH mixture was added to each cell.

The Chemistry was stirred and blended in situ.

### Weld

The Cathode assembly was bonded to the loaded Anode Assembly to form the battery. The bond was accomplished by a simultaneous welding of all three cells, using a custom-built welding apparatus. A copper tool was heated and dumped its heat only into the seam to be welded.

A complete, loaded Anode Assembly was placed into the alignment pocket in the weld base and butted into the corner for alignment.

A Cathode Assembly was obtained and inspected for quality. Each cathode in the assembly had about 1.0 mm of expanded nickel protruding from the active (black) area into the fiber-reinforced glue area, and electrically isolated (i.e. no touching nickel on adjacent cathodes). Further, the interface between the cathodes and the fiber-reinforced glue borders should be free from large bubbles and discontinuities.

The protruding mesh tabs of the Cathode Assembly are bent up (toward the inside of the battery) at 90° C. such that they will tuck tightly against the Walls of the Anode Assembly. The Separator of each cathode was wetted with 4 drops (about 0.2 mL) of 13 M aqueous potassium hydroxide (KOH) solution immediately prior to welding (within 5 minutes).

The Cathode Assembly was positioned on top of the Anode Assembly face down with bent tabs pointing downward (wet Separator toward the insides of the battery). The Cathode Assembly was aligned by eye such that the active areas are directly atop The Chemistry, and the hot glue borders are directly atop the Walls. Nickel tabs on the cathode assembly oppose the corresponding tabs on the Anode Assembly.

A sheet of parchment paper was placed above the battery to be welded as a release film.

The hot plate was set and preheated to 350° C., and a Weld Tool placed directly on top, copper side down, to be heated. The tool was heated for about 5 minutes, or until smoke just began to emerge from a wood handle.

### Serial Electrical Connection

The three cells of the battery were connected in electrical series. The serial connection was achieved with copper interconnects and brass set screw terminals. Copper foil was soldered directly to the expanded nickel tabs to achieve low resistance connections, which were insulated with Kapton tape to prevent shorting. The power outputs are terminated with soldered brass set screws which interface the Battery Cartridge with the Specialty Circuit.

Each nickel tab was tipped with solder using a flux (Lenox Sterling Flux) and rosin-core solder (60/40 Sn/Pb). A soldering iron (Weller) was fit with the fattest tip available for maximum heat transfer. The soldering iron was set to about 430° C.

Copper foil (Alloy 110, McMaster-Carr, 0.127 mm thick, 15.4 cm wide roll) was folded over to make a double-thick strip and was trimmed with scissors to be about 3.5×47.0 mm. Two of this size copper interconnect foil were soldered between adjacent nickel tabs along the sides of the Z to form the two necessary serial connections. The soldered connections were covered with 12.7 mm Kapton tape (McMaster-Carr).

To make terminal connections, 3.5 mm copper foil strips were soldered to the terminal electrodes (i.e. positive-most cathode, negative-most anode) and wrapped around the battery such that they formed terminals. Copper foil for the cathode (+) terminal was routed on top of an existing interconnect, which should already have been insulated with tape. The terminal copper foil runners were initially cut too long, then trimmed to final size to be accessible via the holes in the Endcap.

Terminals were then made by soldering brass set screws #4-40 in the proper locations to fit the holes in the Endcap. For alignment, the Endcap was used as a template.

The Canister: The Canister had two sheet metal parts, a Teflon film, and a plastic cap sealed together with epoxy.

A sheet of the Teflon Film (Donaldson Company, AX11-089) was cut to approximately 78×61 mm and laid inside the perforated inner canister.

Epoxy (Gorilla glue epoxy; Home Depot) was mixed in a weigh boat and a very thin layer applied with a toothpick to the inner wall of the inner canister.

The Battery Cartridge was placed, cathode (black-colored expanded nickel) side down against the Teflon Film, into the inner canister, leaving the terminals to hang out the open side.

With the remaining epoxy, cover the inner walls of the outer canister, was inserted into the inner canister and battery into the outer canister. Some epoxy squeezed out the sides.

The metal part of the canister was compressed with an abundance of spring clamps and rubber bands.

Mold Fabrication: A two-part injection mold for forming the hot melt adhesive Walls was milled from 9.525 mm Aluminum 6061-T6 plate (McMaster-Carr) on a JET JMD-18, then coated in a permanent mold release (baked-on PTFE film).

### EXAMPLE 2

This example illustrates an electrical circuit board (the “Specialty Circuit”). The Specialty Circuit is an electrical interface between a custom zinc-air primary battery charging the internal, Li-ion battery of a consumer electronic device, such as an iPhone 5. The Battery Cartridge product encompasses a 3-cell or 4-cell, series-connected, zinc-air battery and circuitry to charge the internal Li-Ion battery of an iPhone5, and the Specialty Circuit serves as an interface between the Battery Cartridge and the iPhone 5.

iPhone Battery Specification: The iPhone battery is a 3.8V Li-ion type with varying energy capacity levels between 5.45 and 5.92 Wh. The supplied voltage to the battery is likely greater than this voltage. There are two distinct levels of charging current that the iPhone battery will accept, 500 and 1000 mA.
USB power source: The circuit board includes a micro B-USB connector for connection to a standard USB source. Power supplied through the USB connector will take priority for charging the iPhone battery, for example, if both a Zn-air battery and powered USB are supplied, the iPhone charging power will be sourced via USB. The minimum voltage threshold for valid power, supplied by the USB is 4.00V. Any voltage above this threshold is sufficient for charging the iPhone battery.
Zn-air power source: The zinc-air cells contained within the Battery Cartridge may exhibit undesirable characteristics if their individual voltage falls below 0.9V/cell. This extrapolates to 3.6V for the battery with 4 cells, and 2.7 V for the Battery Cartridge containing 3 cells, and additionally a 15% safety margin has been added. Therefore, the associated circuitry has a cutoff threshold of 4.14V for a Battery Cartridge containing four cells and 3.105 V for a Battery Cartridge containing three cells. This current was limited to 1,300 mA.

The maximum input voltage, when supplied by the USB was 5.50 V (nominally 5.00 V). The maximum input voltage, when supplied by the zinc-air battery, was 6.6 V (1.65 V/cell). Nominally, 5.6 V (1.4 V/cell). This is for the 4-cell Battery Cartridge variation. For the remainder of this Example, only the 4-cell variation of the Battery Cartridge is described.

The charging circuit steps sequentially through increasing levels of input current until this threshold is reached. The circuit allows charging at this level until the voltage threshold of 4.14V is reached, at which time the circuit steps down the input current level until the voltage exceeds the minimum threshold. The operation continues until the zinc-air battery can no longer support the charging and the charging current will cease.

Indicators: LED status indicators provide for a visual indication of the state of charge of the zinc-air battery. The function is activated momentarily by depressing a switch.
Communication: When an external USB source is present, data is allowed to pass-through the charging circuit to the phone, permitting high speed data transfer from a computer.
Firmware Update: There exists a means of updating the microcontrollers internal firmware as provided through an on-board SOIC test clip.
Connections: The circuit receives an input from a standard female micro-B, USB to connect to a standard USB connection. The output connector is a male Lightning connector.
Dimensions: In a preferred embodiment, a printer circuit board assembly does not exceed 1.73 inches×0.6 inches and the total height does not exceed 0.1875 inches.
Switches: A single mechanical pushbutton switch enables the LED indicator bar graph for visual feedback of the Zn-air state of charge. LED indicator lights are an optional feature.
Electrical Protection: An output voltage monitor and clamp provides protection against excessive voltage being applied to the iPhone 5 Li-ion battery. Electrostatic discharge protection is provided to all pins and any surfaces that could be become exposed to human touch.
Mechanical Protection: The printed circuit board assembly is protected from mechanical shock and vibration causing components to become dislodged.
DC/DC Conversion with the LT1512: The LT1512 is a current-mode Single-Ended Primary Inductance (SEPIC) DC/DC converter. A SEPIC converter can both buck and boost input voltages to the desired output potentials, and because the current limit is programmable. One example of a circuit is shown in FIGS. 9A and 9B.

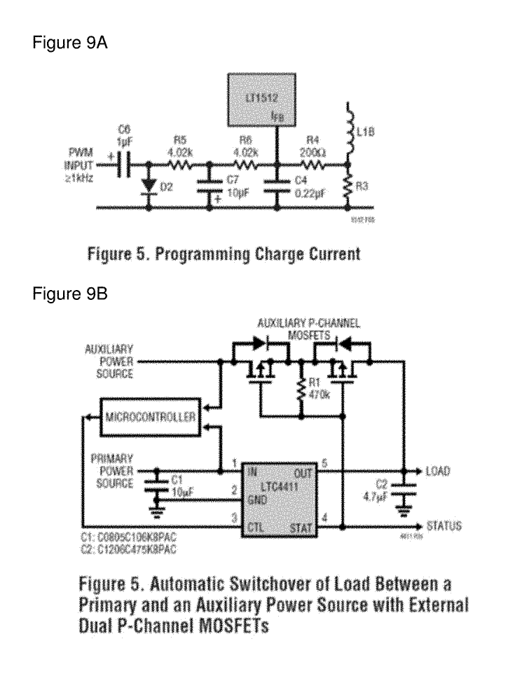

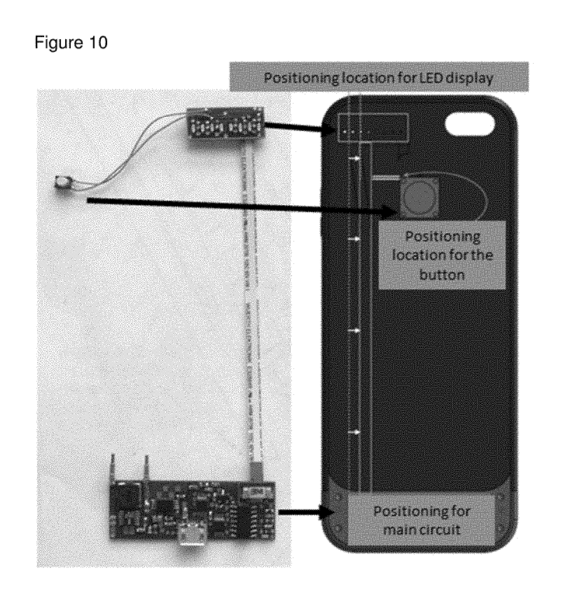

Because the current limit needs to be actively changed throughout the life of the zinc cell, a digital solution was needed in order to adjust the current of the Ifb pin. For this reason, the circuit shown in FIG. 8 was added to interface the 1512 with the on-board microcontroller.

At this time, the 1512 portion of the circuit has been designed to provide a 4.9V output with an initial 0.5 A current limit. As the zinc potential reaches 4.2V, the microcontroller adjusts the current limit to be slightly lower than before, which raises the zinc's potential. After a set amount of current steps, the booster safely disengages the zinc cell.

In order to provide the consumer the ability to charge from an external power source, a circuit (Power ORing with the LTC4411) was designed to allow only one selected input to pass through to the phone. A simple method would be to use two identical diodes to condition the inputs to only allow the input with the higher potential through to the load. This solution works, but introduces some losses and no control can be implemented using a microcontroller. Instead, the LTC4411 allows full control over which power source is used, and losses are minimal. FIGS. 8 and 9A and 9B show how the circuit was implemented.

USB Data Switching using the TS3USB221: Most phone case/charger schemes require the user to remove the case in order to transfer data at high speeds through a USB cable because specific data signals at D+ and D− are required so that the phone knows that it can pull power from the attached accessory. To get around this problem, we have implemented a simple USB-worthy multiplexer that is controlled by the STAT pin of the LTC4411, meaning that if an external USB power source is seen, then USB data will always be allowed to pass through to the phone.

Visual Feedback using LED indicators: Controller (an Atmel ATTINY20) implements an external interrupt which triggers when the external switch is depressed. Upon interrupt, the LED's light up to display the current step. The controller also handles the ADC of the zinc potential. Upon seeing a level smaller than 4.2V, the PWM output is altered to set the new current limit.

The circuit contains firmware specially designed to integrate with the Battery Cartridge to maximize the output current (and the benefit to the user of faster charging times) while also maximizing total energy output (benefit to the user through more charge capacity. This functionality is performed via a “current ladder” mechanism. The “current ladder” operates by applying a sequence of decreasing constant current loads while monitoring voltage. For each step of the ladder, battery voltage is monitored as it begins to lower, and when the battery reaches 1.05V per cell, the current is reduced to the next sequential current. There are 10 steps in the ladder, as shown in Table 5.

TABLE 5
Decreasing current ladder employed by the Specialty
Circuit to maximize current output versus total
energy output of the Battery Cartridge.

| Current Ladder | DC | Triggering Voltage |
|---|---|---|
| Step # | Current (A) | (per cell) (V) |
| 1 | 1.3 | 1.05 |
| 2 | 1.2 | 1.05 |
| 3 | 1.1 | 1.05 |
| 4 | 1.0 | 1.05 |
| 5 | 0.9 | 1.05 |
| 6 | 0.8 | 1.05 |
| 7 | 0.7 | 1.05 |
| 8 | 0.6 | 1.05 |
| 9 | 0.5 | 1.05 |
| 10 | 0.4 | 0.90 |

### EXAMPLE 3

In a preferred embodiment, the Battery Cartridge connects to the Specialty Circuit. Given that the Specialty Circuit is designed to be reused and the Battery Cartridge is designed for single use, there is an imperative to develop a reusable part that houses the Specialty Circuit that serves as a reusable connection to both the Battery Cartridge and the consumer electronic device.

One such way to accomplish this is to house the Specialty Circuit in a unit made of plastic or metal, or any other suitable material, and also that contains the connections to the Battery Cartridge and consumer electronic device components.

Consumer electronic device users often purchase and utilize third-party casing units to protect their device from physical damage, and for their heightened haptic grip properties, among other reasons. In a preferred embodiment, the Specialty Circuit is housed within a Protective Case, which now doubles as the protective unit for the consumer electronic device and a method of utilizing the invention Battery Cartridge invention in one step. This also frees the end user from carrying around the Specialty Circuit housing unit as a separate piece.

In one embodiment illustrated herein, it is designed to house an iPhone 5. The casing material incorporates a compartment for the electronic circuit, connection terminals for the Battery Cartridge, a male lightning connector for purposes of connecting to an iPhone, a void volume to house the Battery Cartridge once engaged, and a housing unit for the LED board. The model was fabricated on a 3D Printer using acrylonitrile-butadiene-styrene (ABS) as the base material.

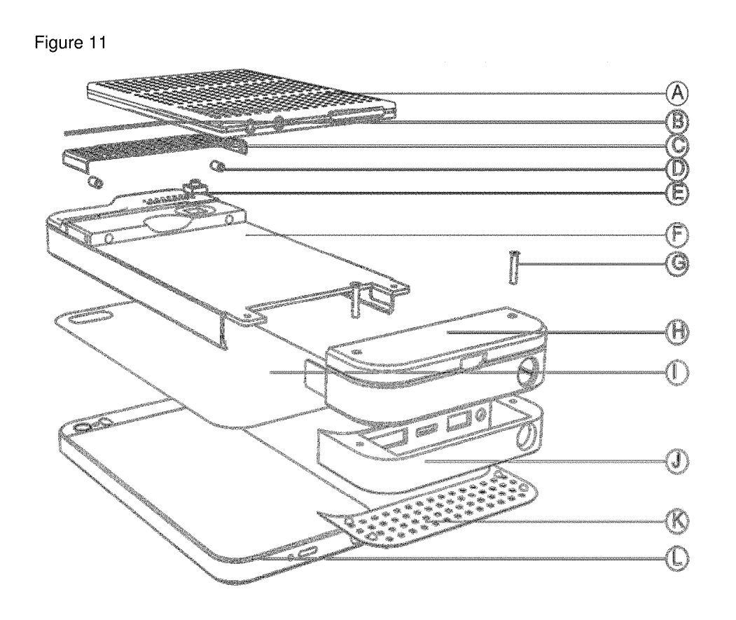

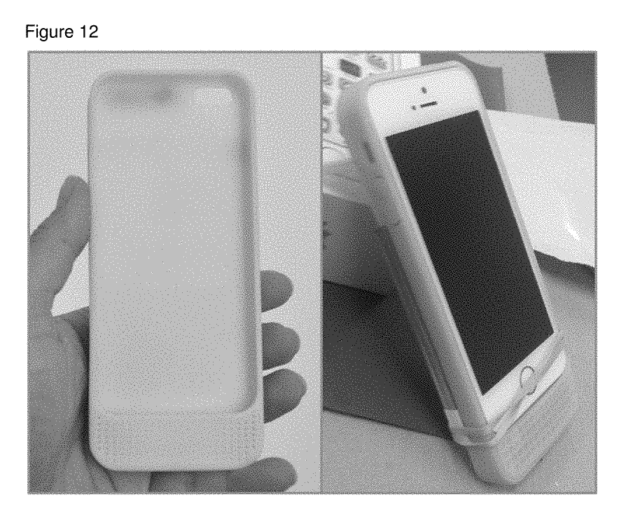

FIG. 11 depicts a rendering of the example Protective unit designed to accept the invented Battery Cartridge (A) and containing the following components: (B) hinge rod, (C) silicone part, (D) spring plunger (ct. 2), (E) switch, (F) case top part, (G) screw, 1.5 mm (ct. 2), (H) case lower part, (I) soft touch insert, (J) Specialty Circuit holder, (K) speaker grill, (L) iPhone 5 (example consumer electronic device to be used by the Protective Case).

### EXAMPLE 4

This example describes Prototype 1. Three separate zinc-air cells connected in electrical series and utilizing the construction method are described in Example 1. It was fabricated and tested for performance. The prototype Battery Cartridge contained three separate zinc-air cells that had an active surface area of approximately 11.19 cm², arranged in a face-up, side-by-side configuration. The particular attributes of this cartridge prototype include are as follows.

A cartridge was constructed using primarily a molded, hot-melt-adhesive frame containing three encapsulated individual zinc-air cells with a 3.8 mm overall thickness. The anode was reinforced with a double layer of polyaramid and hot-melt adhesive co-polymer. The anode current collector consisted of 0.005″ thick polished brass-260 (McMaster-Carr) with soldered nickel mesh tabs used for inter-electrical connections. The NDCPower proprietary Cathode was reinforced with single layer of polyaramid and hot-melt adhesive co-polymer.

The disclosed cathodes (described in Example 2) were fabricated without a 1 mm border region. The porous chemical separator comprises two sheets of “Kimwipe®” (Kimberly-Clarke) woven cellulosic fiber, pre-wetted with 0.25 mL of 13 M potassium hydroxide (KOH) solution. The anodic slurry was 5.11 g Grillo Werks brand zinc reductant fuel, and 4.06 g carboxymethylcellulose gel solution (12.9 M KOH/2% carboxymethylcellulose High Viscosity [Sigma-Aldrich], density=1.49 g/mL).

A programmable load was electrically connected to the prototype cartridge. The programmable load supplies a current in order to measure the voltage and power outputs of the prototype cartridge device. A variable current was utilized and which serves to maximize the total amount of power that can be obtained instantaneously at any given time from the device. Instantaneous power is a useful attribute for a battery because it decreases waiting time to recharge consumer electronic devices. The current was initially set at 1.2 A. The voltage was monitored and once a reading below 3.15 V was encountered, the current load applied was dropped by 0.1 A. This caused the voltage to temporarily rise for a time. As the battery continued to discharge it again fell below the value of 3.15 V and the load was decreased by another 0.1 A. The lowest value allowed by the programmable load was 0.4 A at which time the voltage was allowed to fall to a final cutoff value of 2.7 V. The applied load was terminated at this point in order to avoid a deep-discharge of the battery. Deep discharge has a number of potential undesirable effects including expansion risk (bursting), hydrogen formation, and overheating. A programmable load controlled by a computer test station was utilized to mimic the behavior of the specialized circuitry. The cellular phone charging data indicate this functionality as controlled by the specialized circuitry developed for this purpose.

The voltage (V) response versus time (hours) for Prototype 1 with the discharge conditions is shown in FIG. 13. The measurement represented the electrochemical potential (voltage) of the prototype cartridge device which contained three individual zinc-air cells interconnected in electrical series by soldered nickel mesh tabs between the cells, and copper-foil tabs conjoining the protruding electrodes for connection to the programmable load.

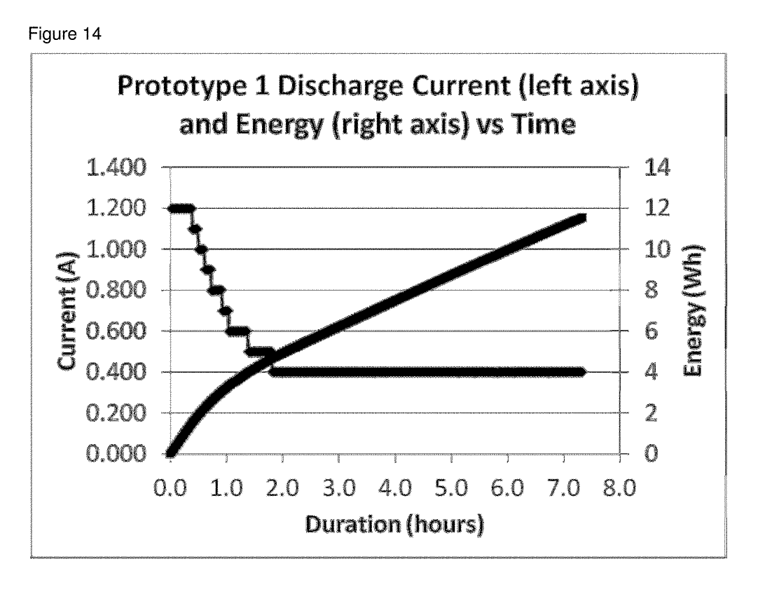

The current (A) response versus time (hours), and total energy (Wh) as described by the aforementioned discharge conditions is shown in FIG. 14.

### Prototype 2 Description:

A Battery Cartridge was fabricated with three separate zinc-air cells connected in electrical series and utilizing the construction method as described by Example 1. Three separate zinc-air cells had an active surface area of approximately 11.19 cm². The cells were arranged in a face-up only, side-by-side configuration. The particular attributes of this cartridge prototype include are as follows.

A Battery Cartridge was constructed using primarily a molded, hot-melt-adhesive frame containing three encapsulated individual zinc-air cells with a 3.8 mm overall thickness. The anode was reinforced with a double layer of polyaramid and hot-melt adhesive co-polymer. The anode current collector consisted of 0.005″ thick polished brass-260 (McMaster-Carr) with soldered nickel mesh tabs used for inter-electrical connections. The cathode was not reinforced with a layer of polyaramid and hot-melt adhesive co-polymer. During the test there was an absence of external compression on the cartridge assembly. This differed from the embodiment described in the previous Prototype 1 construction.

The disclosed cathodes were fabricated without a border region. The porous chemical separator consisted of two sheets of “Kimwipe®” (Kimberly-Clarke) woven cellulosic fiber, pre-wetted with 0.25 mL of 13 M potassium hydroxide (KOH) solution. The anodic slurry consisted of 5.11 g Grillo Werks brand zinc reductant fuel, and 4.66 g carboxymethylcellulose gel solution (12.9 M KOH/2% carboxymethylcellulose High Viscosity [Sigma-Aldrich], density=1.49 g/mL).

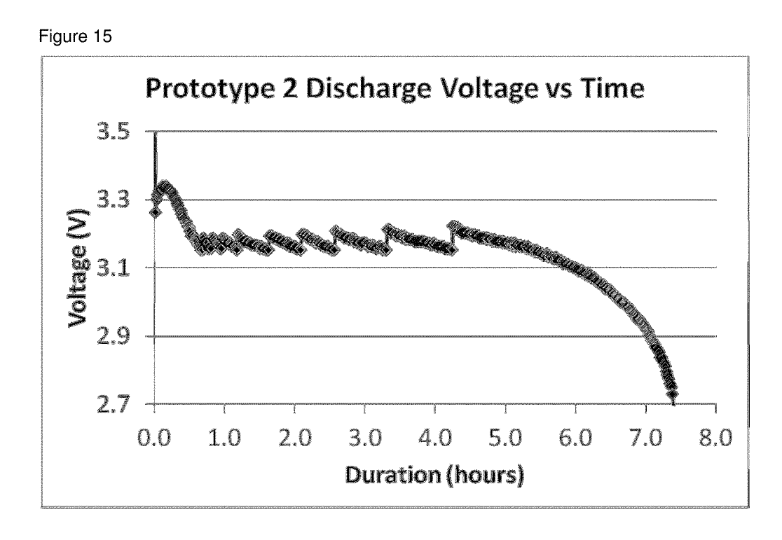

A programmable load was electrically connected to the prototype cartridge. The applied current profile was identical to the aforementioned Prototype 1 description. FIG. 15 depicts the voltage response versus time for prototype 2. The measurement represented the electrochemical potential (voltage) of the prototype cartridge device which contained three individual zinc-air cells interconnected in electrical series by soldered nickel mesh tabs between the cells, and copper-foil tabs conjoining the protruding electrodes for connection to the programmable load.

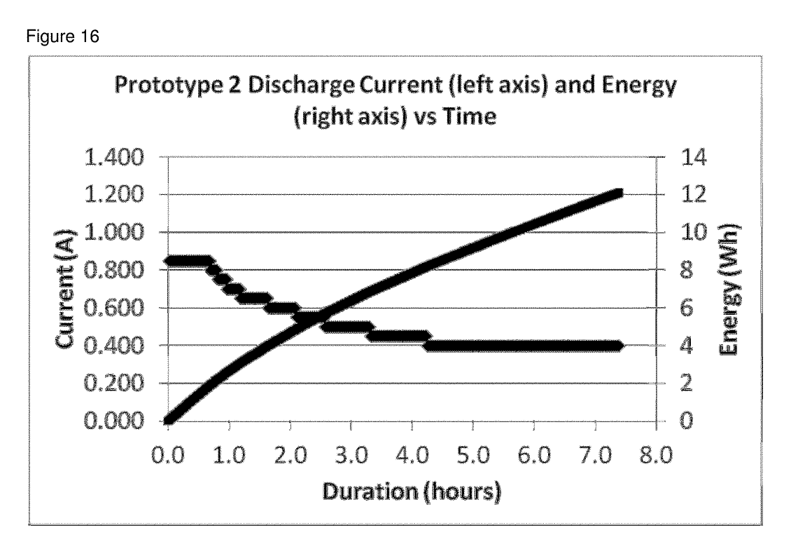

FIG. 16 shows current (A) response versus time (hours), and total energy (Wh) for Prototype 2.

Prototype 1 had discharge characteristics that include faster discharge rate (higher current) when compared to Prototype 2. In another comparison, Prototype 2 has a longer charging cycle than Prototype 1.

### Prototype 3 Description:

A four-cell breadboard lab-prototype was constructed that was similar in size and scope to Prototypes 1 and. It was constructed for purposes of testing the functionality, efficiency, and operating parameters of the Specialty Circuit (Example 2). The breadboard prototype device was connected to the Specialty Circuit (“input” readings) and the specialty circuit was connected to a fully discharge (0% charge) iPhone 5c (“output” readings).

### Prototype 4 Description:

A four-cell prototype was constructed. The prototype Battery Cartridge contained four separate zinc-air cells that had an active surface area of approximately 17.95 cm² each.

### Prototype 4 Discharge Description:

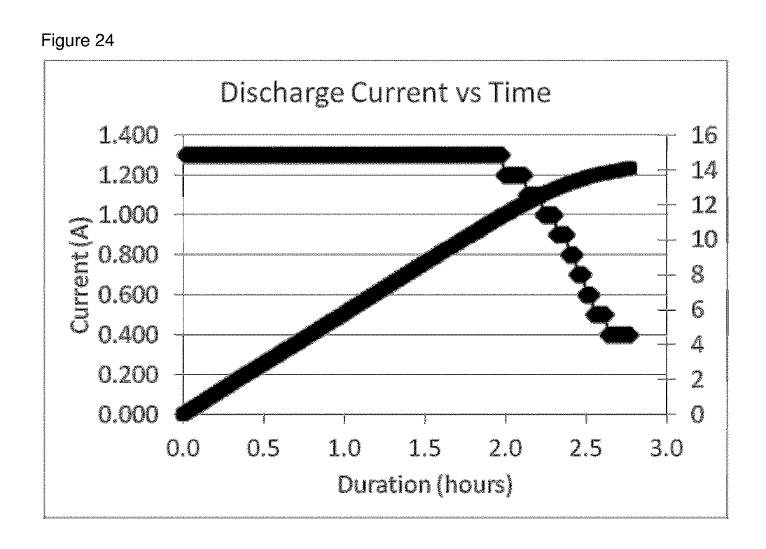

A programmable load was electrically connected to the prototype cartridge. The measurement represented the electrochemical potential (voltage) of the prototype cartridge device which contained three individual zinc-air cells interconnected in electrical series by soldered nickel tabs between the cells, and copper-foil tabs conjoining the protruding electrodes for connection to the programmable load. The current (A) response versus time (hours), and total energy (Wh) as described by the aforementioned discharge conditions, are shown in FIG. 24.

Analysis of Prototype 4: This prototype has two-sided architecture with two cells per side. It indicates the ability of reaching high current and power outputs and also achieving a high total energy.

### Data Comparison:

The data in Table 6 presents selected characteristics of each of the four prototype units:

| | Proto- | Proto- | Proto- | Proto- |
|---|---|---|---|---|
| Description of Parameter | type 1 | type 2 | type 3 | type 4 |
| Prototype Circuit | No | No | Yes | No |
| Utilized | | | | |
| During Test | | | | |
| Current Sink | Prog. | Prog. | iPhone | Prog. |
| Utilized | Load* | Load | 5c | Load |
| During Test | | | | |
| Number of Cells | 3 | 3 | 4 | 4 |
| Single Cell Length (cm) | 5.14 | 5.14 | 5.24 | 5.24 |
| Single Cell Width (cm) | 2.18 | 2.18 | 3.42 | 3.42 |
| Surface Area (cm²) | 11.19 | 11.19 | 17.95 | 17.95 |
| Capacity (mAh) | 3,659 | 3,829 | 1,739 | 3,213 |
| Energy (Wh) | 11.5 | 12.1 | 8.1 | 14.1 |
| Discharge Duration (h) | 7.3 | 7.4 | 3.5 | 2.8 |
| Ave Current (mA) | 499 | 517 | 504 | 1,160 |
| Ave Current | 44.6 | 46.2 | 28.1 | 64.6 |
| Density (mA/cm²) | | | | |
| Average Power (mW) | 1,573 | 1,632 | 2,360 | 5,092 |
| Average Power | 46.9 | 48.6 | 32.9 | 70.9 |
| Density (mW/cm²) | | | | |

*Prog. Load = Programmable Load

### Data Comparison to Energizer P355 and P425 Prototypes:

Energizer Data as published in the following disclosure:
http://data.energizer.com/pdfs/zincairprismatichandbook.pdf (pages 6-8)

### EXAMPLE 5

This example illustrates a preparation of a cathode component of the disclosed prismatic battery.

Preparation of the cathode material: To a Ziploc bag, 5 g of catalytic particles (see Example 6), and 7 g of carbon particles (Vulcan XC-72R, Cabot, Inc.) were added. In a separate 100 mL beaker, 50 mL deionized water and 7.5 mL 60% weight by weight PTFE emulsion (Teflon® DISP 30, Fluorogistix) was added while stirring, creating a diluted PTFE emulsion. Approximately half of the diluted PTFE emulsion was added to the Ziploc bag, which was then sealed, shaken and squeezed by hand until the mix appeared to be homogenous by sight and feel. The remaining diluted PTFE emulsion was added to the Ziploc bag, the bag was sealed, and the material was again shaken and squeezed until the mix appeared to be homogenous by sight and feel. This process results in a dough composition consisting of 9.2% PTFE (emulsified), 6.8% catalytic particles, 9.6% carbon particles and 74.4% water, by weight when wet, and 36.0% PTFE (emulsified), 26.7% catalytic particles, 37.3% carbon particles, by weight, once dried.

Preparation of the decal: The cathode material was formed into a decal. A stainless steel frame with external dimensions of 100 mm×40 mm, and further possessing an internal cavity of 21.77 mm×51.43 mm, and possessing a thickness of 0.91 mm, was procured. A piece of Kynar film (150 mm×150 mm and 0.25 mm thickness) was placed on a flat surface. The stainless steel frame possessing the aforementioned cavity was centered on the Kynar film. Kynar film typically possesses both a shiny face and a dull face. The shiny faces were placed facing the dough material. Approximately 3 g of the cathode material was placed in the cavity of the stainless steel frame. This was enough material to completely fill the cavity with a slight excess. A second Kynar film was placed over the dough and frame, so that it was approximately aligned with the bottom most Kynar film. An operator utilized light pressure from a rolling pin to flatten the dough material uniformly, occasionally stopping to peel back the top-most Kynar film slightly to remove excess dough that had been ejected from the cavity. The decal was exposed by removing the top-most Kynar film carefully, as to not disturb the intact decal. The stainless steel frame was carefully removed, leaving an intact decal carried on the bottom-most Kynar film.

Pressing the electrode: A piece of expanded nickel mesh (“mesh”) of 23.77 mm×58 mm dimensions was cut from a larger roll of stock material (7Ni7-077-F-SRO, 0.18 mm thickness, Dexmet Corporation). A piece of kraft paper (40#, white, Pacon) 100 mm×50 mm was procured. The mesh was placed centered on top of the kraft paper. The cathode material decal was inverted and placed asymmetrically on the nickel mesh, such that a 1 mm border of mesh remains uncovered by the decal along 3 adjacent sides including both 58 mm dimensions and one of the 23.77 mm dimensions. The asymmetric decal placement allows for a convenient tab for current collection. The operator gently rubbed the back of the Kynar film to assist in the transfer of the decal to the mesh. The Kynar film was carefully peeled back exposing the decal that has been transferred onto the mesh.

A parallel plate, four-column hydraulic press (Carver) was used to press the electrode. A stack made of kraft paper material was used to absorb moisture resulting from the pressing procedure: On a flat surface of PTFE-coated fiberglass sheet of 150 mm×150 mm four pieces of brown kraft paper (40#, Pacon) of 150 mm×150 mm dimensions were placed substantially aligned on top of each other. A single sheet of white kraft paper (40#, Pacon) of the same dimensions was then placed on the stack. The mesh and decal (facing up) was placed on the stack, taking care to ensure the stack components remained centered. This was followed by an additional piece of white craft paper, four pieces of brown craft paper, and a final, overlaid PTFE-coated fiberglass sheet. The stack was placed into the press, taking care to not disturb the alignment, and 2 metric tonnes (1.8 MPa) were applied for one minute. The stack was removed from the press and all eight pieces of brown craft paper were removed (four below and four above of the mesh/decal and white craft papers), and replaced with five fresh brown craft paper pieces; three above and two below the mesh/decal and white craft papers. The stack was placed into the press and load was applied for a second time at 3 metric tonnes (2.7 MPa) for a period of two minutes. The stack was removed from the press and the brown craft papers were removed and replaced with one piece of brown craft paper on each side of the mesh/decal and white craft papers. The stack was placed into the press and pressure was applied a third time at 4 metric tonnes (3.6 MPa) for two minutes. The stack was removed from the press, the brown craft papers removed, and the white craft papers were carefully removed starting with the top-most piece, followed by the bottom (mesh side) white craft paper piece. The electrode was allowed to sit for 24 hours to dry in ambient conditions until a constant mass was obtained.

Sintering the electrode: The electrodes are sintered in a circulating air furnace (Blue M). The electrodes were arranged on aluminum foil and placed on a steel rack such that the cathode were in horizontally oriented. The rack was inserted into the furnace while at room temperature. The furnace was then heated to 350 degrees C. Once the final temperature was achieved the electrodes were allowed to sit for an additional 30 minutes, after which the furnace is switched off and then allowed to cool to room temperature while the electrodes remained inside.

Forming the electrode/gasket/separator assembly: A sandwich is made from Teflon-coated fiberglass film, a cathode (nickel mesh side down, catalyst layer facing up), a KOH-compatible low melting temperature polymer film, about 0.020″ thick (film made from Westward hot glue, 4YR50), a separator (2-layers of Kim-wipe, Kimberly Clark), and another sheet of Teflon-coated fiberglass film on top. The polymer film gasket is shaped as a frame and sized as to provide a circumferential seal over the cathode upon melting, but without covering a significant portion of the active area, and also without covering the substantial portion of the nickel mesh tab. The sandwich is placed into a heated 4-column parallel platen press (Carver, USA), heated to 180° F. and pressed under very gentle pressure of 0.5-1 metric tonne (0.44-0.89 MPa) for 1 minute. During the pressing, the polymer melts and forms a seal with the cathode and its nickel mesh substrate. The pressure is subsequently relieved, the sandwich is removed and allowed to cool to room temperature, and the Teflon-coated fiberglass fabric is peeled away from the cathode, revealing the completed, sealed electrode/separator/gasket assembly.

### EXAMPLE 6

This example illustrates a synthesis procedure for catalytic particles in the cathode portion of the disclosed prismatic battery. To a 2 L Erlenmeyer flask containing a magnetic stir bar was added 1.00 L of isopropyl alcohol and 60.0 g Mn(NO₃)₂.4H₂O (Aldrich). The solid material was allowed to completely dissolve. To the solution was added 20 g of carbon particles (Vulcan XC-72R, Cabot, Inc.). The 2 L Erlenmeyer flask was placed in an ice bath while continuing to stir. To the solution was added 180 mL of 70% NH₄OH, dropwise, over a period of approximately 30 minutes. The solution was allowed to stir for an additional four hours. Ice was replenished in the ice bath to ensure the solution remained chilled. The solution was filtered under vacuum using an appropriately sized Buchner funnel and qualitative filter paper (Ahlstrom, Grade 601). The filtrate material was allowed to air dry over a period of 12 hours, and then dried in an oven at 60 to 80° C. for two hours. The dried material was removed from the oven and ground with an appropriately sized mortar and pestle. The ground material was placed in a vacuum oven and heated to 90° C. for 30 minutes. A positive displacement roughing pump was used to create the vacuum. The oven temperature was slowly ramped up according to the following schedule:

| Temperature (degrees C.) | Time (min) |
|---|---|
| 100 | 5 |
| 105 | 5 |
| 110 | 5 |
| 115 | 5 |
| 120 | 30 |
| 125 | 15 |
| 130 | 15 |
| 135 | 15 |
| 140 | 15 |
| 145 | 15 |
| 150 | 30 |
| 200 | 120 |

After the drying procedure was finished the oven was turned off and allowed to cool to under 100° C. The catalytic particle material was placed in a ceramic crucible and milled in a planetary ball mill (Retsch PM400) using 4 mm stainless steel balls at 200 r.p.m. for 15 minutes.

We claim:

1. A cartridge for an electronic device power system configured as a flat, prismatic, air-breathing zinc-air battery comprising (a) an anode assembly having a structural backbone, current collectors, and a gel solution comprising a mixture of amalgamated zinc powder, aqueous potassium hydroxide and a gelling agent, (b) a thin porous separator sheet composed of non-woven cellulose, (c) a cathode capable of oxygen reduction, having an electrode impregnated with reductive catalyst, and (d) a serialized electrical connectivity path having low ohmic resistance characteristics.

2. The cartridge for an electronic device power system of claim 1, wherein the catalytically active oxygen-reduction cathode is made from nickel mesh, expanded nickel, or a metallic plate with holes or a metallic or conductive non-metallic woven mesh.

3. The cartridge for an electronic device power system of claim 1, wherein the anode current collectors are made with brass which also forms the anode backbone.

4. The cartridge for an electronic device power system of claim 1, wherein the primary battery further comprises a circuit to control power output by controlling current output, reading voltage, and optionally raising or lowering output voltage, or current, of the primary battery.

5. The cartridge for an electronic device power system of claim 4, wherein the current output is controlled with a programmed sequence of adjustable currents.

6. A prismatic format, flat rectangular disposable primary battery comprising two or more zinc-air batteries, wherein each zinc air battery comprises: (a) an anode assembly having a structural backbone, current collectors, and a gel solution comprising a mixture of amalgamated zinc powder, aqueous potassium hydroxide and a gelling agent, (b) a porous separator sheet, and (c) an oxygen-reduction cathode having an electrode impregnated with reductive catalyst.

7. The prismatic format, flat rectangular disposable primary battery of claim 6, wherein the two or more zinc-air batteries are connected in series and wherein each of the cathodes are aligned in a geometric single plane or are aligned in a biplanar configuration, whereby biplanar means two substantially parallel planes.

8. The prismatic format, flat rectangular disposable primary battery of claim 6, wherein the primary battery further comprises a circuit to control power output by controlling current output, reading voltage, and optionally raises or lowers output voltage of the primary battery.

9. The prismatic format, flat rectangular disposable primary battery of claim 8, wherein the current output is controlled with a programmed sequence of adjustable currents.

10. The prismatic format, flat rectangular disposable primary battery of claim 6, wherein the two or more zinc-air batteries are connected in series and wherein each of the cathodes are aligned in a geometric single plane or are aligned in a biplanar configuration, whereby biplanar means two substantially parallel planes.

11. The prismatic format, flat rectangular disposable primary battery of claim 6, wherein the primary battery further comprises a welded seal around each of the two or more zinc-air cells, whereby the welded seal contains any volume expansion of the zinc upon discharge of the primary battery.

12. The prismatic format, flat rectangular disposable primary battery of claim 11, wherein the primary battery further comprises a plurality of microspheres enclosing a vacuum, whereby pressure exerted by volume expansion during discharge will collapse the microspheres.

13. The prismatic format, flat rectangular disposable primary battery of claim 11, wherein the primary battery further comprises a bellows-like structure that is compressible with a vent to provide for expelling a gas.
